(19) United States
(12) Patent Application Publication
(10) Pub. No.: US 2023/0153853 A1
(43) Pub. Date: May 18, 2023

(54) CONTROLLED-ENVIRONMENT FACILITY RESIDENT ACCESS TO PAID NETWORK-BASED ACTIVITIES

(71) Applicant: Securus Technologies, Inc., Carrollton, TX (US)

(72) Inventors: Alexander Noland, Frisco, TX (US); Connor Pickens, Little Elm, TX (US)

(73) Assignee: Securus Technologies, Inc., Carrollton, TX (US)

(21) Appl. No.: 16/676,239

(22) Filed: Nov. 6, 2019

(51) Int. Cl. G06Q 30/02; G06Q 50/26

(52) U.S. Cl. CPC G06Q 30/0217; G06Q 30/0209; G06Q 30/0222; G06Q 50/26

(57) ABSTRACT

A controlled-environment facility paid network-based activity controller, or the like, searches for paid network-based activity opportunities and determines a particular resident of the controlled-environment facility is eligible to participate in a particular activity. If, in accordance with rules and procedures of the controlled-environment facility, the resident is allowed to participate in the activity, an offer is made, on a personal controlled-environment facility resident communication and/or media device of the resident, for the resident to participate in the activity and/or to invite a non-resident to participate in an activity. The resident, and/or non-resident, is presented access to the activity, on the resident's or a non-resident device, in response to acceptance of the option to participate. Interaction, by the resident, via the device, is enabled to carry out the activity. Payment for participation by the resident and/or non-resident is collected and the resident compensated according to the facility rules and procedures.

### TECHNICAL FIELD

The present disclosure relates generally to controlled-environment facilities, more particularly to network access by controlled-environment facility residents and, specifically to controlled-environment facility resident access to paid network-based activities.

### BACKGROUND

According to the International Centre for Prison Studies, the United States has the highest prison population per capita in the world. In 2009, for example, 1 out of every 135 U.S. residents was incarcerated. Generally, inmates convicted of felony offenses serve long sentences in prison (e.g., federal or state prisons), whereas those convicted of misdemeanors receive shorter sentences to be served in jail (e.g., county jail). In either case, while awaiting trial, a suspect or accused may remain incarcerated. During his or her incarceration, an inmate may have opportunities to communicate with the outside world.

Traditional communication services provided residents of controlled-environment facilities (such as correctional facilities) include allowing residents (inmates) to place outbound phone calls to non-residents of the controlled-environment facility. Additionally, non-residents can typically schedule video visitation with residents (inmates) of the controlled-environment facility. Other types of communication available to controlled-environment residents include the ability to exchange email and canned text messages between residents and non-residents of the controlled-environment facility.

Controlled-environment facility residents (inmates) typically have limited funds for such phone calls, and although many controlled-environment facility residents (inmates) may be allowed limited and/or monitored internet access, they typically also have limited funds for premium content. However, controlled-environment facility residents (inmates) typically have significant time on their hands.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is directed to systems and methods which provide controlled-environment facility residents access to paid network-based activities. In accordance with various implementations of the present systems and methods, this controlled-environment facility may be a correctional facility, or the like and the residents, inmates of the correctional facility. The paid network-based activity may be only one or more activities such as taking an online survey, watching an online video, playing an online game, redeeming one or more online coupons, reading one or more online posts, reading one or more emails, and/or shopping online.

A controlled-environment facility paid network-based activity controller, or the like, searches for paid network-based activity opportunities in which residents of a controlled-environment facility are eligible to participate. The controlled-environment facility paid network-based activity controller, or the like, may determine whether a particular resident of the controlled-environment facility is eligible to participate in a particular paid network-based activity, and/or, in accordance with rules and procedures of the controlled-environment facility, the particular controlled-environment facility resident is allowed to participate in the particular paid network-based activity. If so, the controlled-environment facility paid network-based activity controller, or the like, may offer, on a personal controlled-environment facility resident communication and/or media device associated with the particular controlled-environment facility resident, the resident an option to participate in the particular paid network-based activity.

In response to acceptance of the option by the resident to participate in the particular activity, the controlled-environment facility paid network-based activity controller, or the like, may then, present the resident access to the paid network-based activity. Thereby, the controlled-environment facility paid network-based activity controller, or the like, may allow the resident interaction, via their personal controlled-environment facility resident communication and/or media device, with a website, or other access method, to carry out the paid network-based activity. This interaction, by the particular controlled-environment facility resident, with the website, or other access method, to carry out the paid network-based activity may be allowed, in accordance with various implementations of the present systems and methods, over an access block in place in accordance with rules and procedures of the controlled-environment facility.

In accordance with various (further) implementations of the present systems and methods, the controlled-environment facility paid network-based activity controller, or the like, may aggregate a plurality of the paid network-based activity opportunities for which residents of a controlled-environment facility are eligible to participate. Then, the controlled-environment facility paid network-based activity controller, or the like, may, for each paid network-based activity of the plurality of paid network-based activity opportunities, determine if a particular resident of the controlled-environment facility is eligible to participate in a particular paid network-based activity, and if the particular resident is allowed to participate in the particular paid network-based activity. In accordance with such implementations, the controlled-environment facility paid network-based activity controller, or the like, may present, on the personal controlled-environment facility resident communication and/or media device associated with a particular controlled-environment facility resident, the particular controlled-environment facility resident further access to another particular paid network-based activity.

The controlled-environment facility paid network-based activity controller, or the like, may collect payment for participation by the particular controlled-environment facility resident in the paid network-based activity and compensate the resident, in accordance with rules and procedures of the controlled-environment facility, for participation in the paid network-based activity. The compensation to the resident for participation in the paid network-based activity may be used by the resident to purchase media content, video content, television shows, device accessories (e.g., device cases, device keyboards, etc.) music content, games, movies, commissary items, food, beverage, toiletries, and/or the like.

The controlled-environment facility paid network-based activity controller, or the like, may, in accordance with various implementations of the present systems and methods, aggregate a plurality of the paid network-based activity opportunities for which residents of a controlled-environment facility are eligible to participate. Then, the controlled-environment facility paid network-based activity controller, or the like, may, for each paid network-based activity of the plurality of paid network-based activity opportunities, determine if a particular resident of the controlled-environment facility is eligible to participate in a particular paid network-based activity, and if the particular resident is allowed to participate in the particular paid network-based activity. In accordance with such implementations, the controlled-environment facility paid network-based activity controller, or the like, may present, on the personal controlled-environment facility resident communication and/or media device associated with a particular controlled-environment facility resident, the particular controlled-environment facility resident further access to another particular paid network-based activity.

In addition to, or alternatively to, such implementations of the present systems and methods some implementations may search for paid network-based activity opportunities, in general and offer a controlled-environment facility resident operating a controlled-environment facility communication and/or media terminal or device an option to invite a non-resident to participate in at least one paid network-based activity. In response to selection by the resident of the option to invite the non-resident to participate, an invitation may be forwarded, via a controlled-environment facility communication processing system, or the like to the non-resident to participate in the paid network-based activit(y)(ies). In response to the non-resident accepting the invitation to participate in at least one paid network-based activity, the non-resident may then be presented access to the at least one paid network-based activity on a non-resident communication and/or media device. Payment for participation by the non-resident in the paid network-based activit(y)(ies) is collected and, in accordance with rules and procedures of the controlled-environment facility, the resident may then be compensated for participation by the non-resident in the paid network-based activit(y)(ies).

In accordance with various implementations of the present systems and methods, the option for the resident to participate, and/or or to invite the non-resident to participate in the paid network-based activit(y)(ies) may be offered to the resident during initiation of an electronic communication, or the like, for payment of the electronic communication, at least in part. In accordance with such implementations the resident may be compensated by paying for the electronic communication, at least in part, to the extent of the payment for participation by the resident and/or non-resident in the network-based activity, as a result of the resident's and/or non-resident's participation in the paid network-based activit(y)(ies).

In various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processor(s), wherein the memory is configured to store program instructions executable by the processor(s) to cause the system(s) to execute one or more operations disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale, and wherein:

FIG. 1 is a diagrammatic illustration of an example communications environment, wherein an example embodiment of the present systems and methods for controlled-environment facility resident access to paid network-based activities may be deployed in conjunction with a single, or multiple controlled-environment facilities, according to some embodiments;

FIG. 2 is a diagrammatic block illustration of by an example controlled-environment facility paid network-based activity controller, according to some embodiments;

FIG. 3 is a flowchart of an example process for controlled-environment facility resident access to paid network-based activities, in accordance with some embodiments;

FIG. 4 is a flowchart of an example process for controlled-environment facility resident-initiated non-resident access to paid network-based activities, in accordance with some embodiments; and

FIG. 5 is a block diagram of a computer system, device, station, or terminal configured to implement various techniques disclosed herein, according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

For example, various types of controlled-environment facilities are present in today's society, and persons may be voluntary or involuntary residents of such facilities, whether temporarily or permanently. Examples of controlled-environment facilities may include correctional institutions (e.g., municipal jails, county jails, state prisons, federal prisons, military stockades, juvenile facilities, detention camps, home incarceration environments, etc.), healthcare facilities (e.g., hospitals, nursing homes, mental health facilities, rehabilitation facilities, such as drug and alcohol rehabilitation facilities, etc.), restricted living quarters (e.g., hotels, resorts, camps, dormitories, barracks, etc.), and the like. For convenience of explanation, various examples discussed herein are presented in the context of correctional facilities, or the like. For instance, in some of the embodiments discussed below, a controlled-environment facility may be referred to as a correctional facility, jail or prison, and its residents may be referred to as inmates, arrestees, or detainees. It should be understood, however, that the systems and methods described herein may be similarly applicable to other types of controlled-environment facilities and their respective residents (e.g., a hospital and its patients, a school dormitory and its students, etc.).

The present systems and methods relate generally to controlled-environment facilities, more particularly to network access by controlled-environment facility residents and, specifically to controlled-environment facility resident access to paid network-based activities. Such paid network-based activities may include, by way of example, taking online surveys, watching online videos, playing games, redeeming online coupon(s), reading online post(s), reading email(s), shopping online, or the like.

In accordance with embodiments of the present systems and methods, a controlled-environment facility paid network-based activity controller, or the like, searches for paid network-based activity opportunities and determines if a resident of the controlled-environment facility is eligible to participate in a particular activity. If, in accordance with rules and procedures of the controlled-environment facility, the resident is allowed to participate in the activity, an offer is made, on a personal controlled-environment facility resident communication and/or media device, or the like, of the resident, for the resident to participate in the activity, and/or an offer is made for the resident to invite a non-resident to participate in a paid network-based activity. The resident, and/or non-resident, is presented access to the activity, on the resident's or a non-resident communication and/or media device, respectively, in response to acceptance of the option to participate. For the resident, interaction via the device, is enabled to carry out the activity. Payment for participation by the resident and/or non-resident is collected and the resident compensated according to the facility rules and procedures, for participation by the resident and/or non-resident in the paid network-based activity.

Thereby, embodiments of the present systems and methods enable controlled-environment facility residents (inmates), who typically have limited funds for communication services, premium content, or the like, to make use of time on their hands to generate income, such as via a (personal) controlled-environment facility adapted or approved resident communication and/or media device.

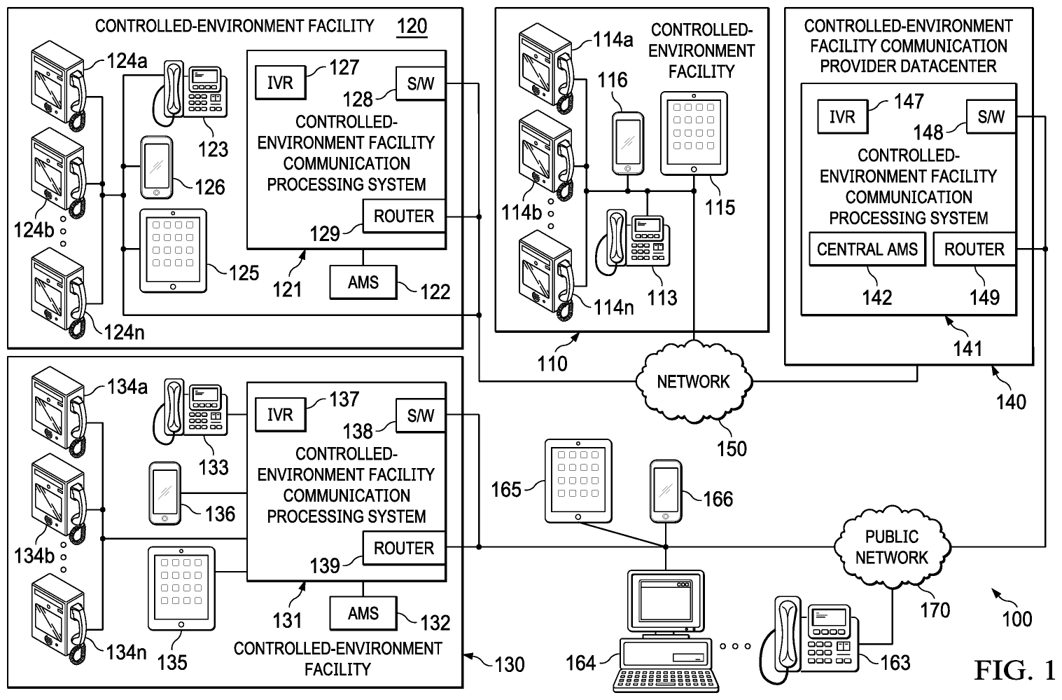

FIG. 1 is a diagrammatic illustration of example communications environment 100, wherein an example embodiment of the present systems and methods for controlled-environment facility resident access to paid network-based activities may be deployed in conjunction with multiple controlled-environment facilities 110, 120 or single controlled-environment facility 130, according to some embodiments. Therein, onsite communication processing system 121, 131, external centralized communication processing system 141, such as may be deployed in a controlled-environment facility communications provider data center (140), or the like may provide telephone services, videoconferencing, online chat, e-messaging, and other communication services to residents of respective controlled-environment facility 110, 120, 130, etc. As illustrated, in some cases, a communication processing system (121, 131) may be co-located with a controlled-environment facility (120, 130, respectively). Alternatively, as also illustrated, a communication processing system (141) may be centrally or remotely located, such as in controlled-environment facility communications provider data center 140 in whole (such as with respect to facility 110) or in part (such as with respect to facility 120). Controlled-environment facility communications provider data center 140, and hence external centralized communication processing system 141, may be connected to such facilities via a public network (e.g., the Internet) or a private network, or the like (e.g., via a secure tunneling protocol over the internet, using encapsulation) (150) and may provide communication services to such multiple controlled-environment facilities. Such controlled-environment facility communication processing systems, particularly when deployed in, or in conjunction with, a controlled-environment facility communications provider data center (140), and/or in conjunction with onsite Administration Management System (AMS) 122, 132 (or a Jail Management System (JMS) in correctional environment embodiments), and/or external centralized AMS 142, may be referred to as a “controlled-environment facility secure communication platform,” or the like. More generally, however, it should be noted that communication systems 121, 131, 141, etc. may assume a variety of forms, comprising, including and/or embodying telephony switches, such as electronic switching systems, or the like, and/or may be configured to serve a variety of facilities and/or users, whether within, or outside of, the respective controlled-environment facility.

Onsite AMS 122, 132 (or a Jail Management System (JMS) in correctional environment embodiments), and/or external centralized AMS 142 may be employed in accordance with various embodiments of the present systems and methods, such as to store and/or implement rules and procedures of the controlled-environment facility. In some embodiments, where the (central) controlled-environment facility communication system (141) is located remotely with respect to the controlled-environment facility (110, 120, etc.), access to AMS (or JMS) 122, 132, etc. may (also) be obtained via a computer network such as, for example, network 150. In various embodiments, the lives of resident/inmates may be electronically managed from intake/booking through release. An AMS (or JMS) deployed in conjunction with one or more correctional facilities provides management of various aspects thereof, such as facility management (including tracking inmates from booking through release), staff management (including time and attendance management and personnel dispatching), call management (including placing and blocking calls, accounting for call charges, commerce, determining credit worthiness of individuals, establishing and maintaining accounts, and handling purchases of goods and services), and inmate/resident management (including managing inmate information and tracking inmate activity). In accordance with embodiments of the present systems and methods, controlled-environment facility AMS 122, 132, etc. (e.g., a JMS with respect to correctional facilities), associated with at least one controlled-environment facility 120, 130 may maintain information with respect to the residents of the respective controlled-environment facility. An external remote, central AMS (142) may maintain information with respect to residents of one or more controlled-environment facilities (e.g., 110, 120). In the context of a correctional facility, the respective JMS or AMS databases may include information such as balances for inmate trust, commissary, media and calling accounts; trial schedule; conviction data; criminal record; sentencing data, time served, time remaining to be served, and release date; cell and cellmate assignments; inmate restrictions and warnings; commissary order history; telephone call history; call recordings made by the facility, known or suspected gang or criminal affiliations; known or suspected affiliates, accomplices, or gang members; and any other information that may be relevant or useful to correctional facility staff to house and maintain inmates.

In some implementations, wherein the controlled-environment facility communication system (121, 131) is located within the controlled-environment facility (120, 130), it may have direct access to a respective AMS (122, 132) for garnering information used in accordance with various embodiments of the present systems and methods. In addition to providing certain visitation and communication operations, communication processing systems 121, 131, 141, etc. and/or AMS (or JMS) 122, 132, 142, etc. may attempt to ensure that a resident's calls, video conferences, online chats, e-messaging, etc. are performed only with non-residents whose identities, devices, email addresses, phone numbers, etc. are listed in that resident's Personal Allowed Number (PAN) or Pre-Approved Contact (PAC) list. Each resident's PAN or PAC list may be stored, for example, in a database maintained by respective AMS (or JMS) 122, 132 or 142, or the like. In addition to PAN or PAC list(s), AMS (or JMS) 122, 132 or 142 (databases), or the like, may also store inmate or resident profile data (RPD), as well as visitation rules applicable to each inmate or resident, Communication Detail Records (CDRs), or similar records, for resident phone calls, video visitations, texts, online chats, e-messaging, or the like.

Residents may use more-or-less conventional telephones 113, 123, 133, or the like to access certain communication services, under control of respective communication processing system 121, 131, 141, etc. Additionally, or alternatively, in some facilities a resident may use an intelligent controlled-environment facility communication and/or media terminal 114a through 114n, 124a through 124n, 134a through 134n, or the like, to place voice calls, as well as for video visitation, under control of respective communication processing system 121, 131, 141, etc. Such an intelligent controlled-environment facility communication and/or media terminal may be referred to as an Intelligent Facility Device (IFD) (114, 124, 134), which may be a video phone particularly adapted for use in a controlled-environment facility, but which may be used to place voice calls, as well. Alternatively, or additionally, IFDs may take the form of, or be used as, a voice phone that may have a touchscreen interface. Generally speaking, IFDs may be disposed in a visitation room, in a pod, as part of a kiosk, etc.

Additionally, or alternatively, in some facilities, residents may use a personal computer wireless device, such as a tablet computing device 115, 125, 135, smartphone/media player 116, 126, 136, or the like, which may have been adapted and/or approved for use in a controlled-environment facility. Such a tablet computing device or smartphone/media player may be referred to as an intelligent personal controlled-environment facility resident communication and/or media device, Intelligent Resident Device (IRD), or the like, and in a correctional institution embodiment, as an intelligent inmate personal communication and/or media device, Intelligent Inmate Device (IID), or the like.

As will be appreciated, IRDs, IFDs, or other similar devices, as well as phones 113, 123, 133, etc. have communications capabilities, to enable a party to participate in telephone calls, video visitation sessions (video calls), or the like with other call parties, such as non-residents, under control of respective communication processing system 121, 131, 141, etc. IFDs 114a through 114n, 124a through 124n, 134a through 134n, IRDs 115, 116, 125, 126, 135, 136, or other similar devices, may be referred to collectively or individually as “(a) controlled-environment facility resident communication and/or media device(s),” or the like.

In some embodiments, IFDs 114, 124, 134, etc. may be implemented as a computer-based system. For example, each of IFD may include a display, camera, and handset. The display may be any suitable electronic display such as, for example, a Liquid Crystal Display (LCD), a touchscreen display (e.g., resistive, capacitive, etc.), or the like, whereas the camera may be any suitable imaging device such as, for instance, a video camera or webcam equipped with Charge-Coupled Devices (CCDs), Complementary Metal-Oxide-Semiconductor (CMOS) active pixel sensors, etc. A handset may be similar to a traditional telephone handset including an earpiece portion (with a loudspeaker), a handle portion, and a mouthpiece portion (with a microphone). During a video visitation session, IFDs may be configured to capture a video image of a resident to be transmitted to a non-resident using the camera, and to display a video image of the non-resident to the resident using the display. IFDs may also be configured to capture an audio signal from the resident to be transmitted to a non-resident using the mouthpiece portion of the handset, during video visitation call or during a voice call. Complementarily, the IFD may provide an audio signal from the non-resident to the resident using the earpiece portion of the handset, during such calls. Additionally, or alternatively, audio received from the non-resident may be reproduced via a loudspeaker, and audio provided by the resident may be captured via a microphone.

IFDs may be a replacement for typical telephones provided in controlled-environment facilities, such as rehabilitation centers, jails and prisons, utilizing existing facility telephony wiring. While the IFDs are generally illustrated in FIG. 1 as hardened, wall-mounted devices, IFDs may also take the form of a kiosk-type terminal or the like. In some cases, IFDs may assume the form of any computer, tablet computer, smart phone, etc., or any other consumer device or appliance with audio and/or video conferencing capabilities. For example, in a correctional facility environment a tablet computing device may be mounted on a wall, in a hardened case as an IFD. IFDs may replace a typical pay phone found in some facilities and may provide touch screen computer functionality that enables a resident to perform “self-service” tasks such as setting up doctor appointments, scheduling visitation, viewing schedules, checking the status of his or her case and/or requesting other controlled-environment facility services. The intelligent facility device may include an RFID or biometric reader, or the like to enable identification of each resident. In addition, the intelligent facility device includes, as noted, a built-in camera and telephone handset to enable a resident to use video conferencing to meet face to face with attorneys, family and friends. Further, in accordance with embodiments of the present systems and methods, the intelligent facility device may provide controlled-environment facility residents limited and/or monitored internet access. In accordance with embodiments of the present systems and methods, IFDs 114, 124, 134, etc. may be employed to facilitate implementation of embodiments of the present systems and methods, and/or to carry out all or certain aspects of embodiments of the present systems and methods.

As noted, IRDs may be tablet computing devices 115, 125, 135, etc., or smartphone/media players 116, 126, 136, etc., adapted and/or approved for use by residents of the respective controlled-environment facility (within the controlled-environment facility) 110, 120, 130, etc. Each IRD may be particularly adapted for use in a controlled-environment. For example, such an IRD may be “stripped-down,” particularly from the standpoint of what apps are provided or allowed on the IRD, and/or connectivity afforded to the IRD. By way of example, such an IRD may employ an operating system kernel that has been rebuilt for use in such a tablet computing device in a controlled-environment facility. As a further example, such an IRD may be adapted to only connect to a network provided by the controlled-environment facility, and/or in only certain locations, within the controlled-environment facility, such as may be controlled by availability of Wi-Fi access, or the like, only being available in certain areas, as discussed above. That is, for example, where access may be compartmentalized, leveraging the structure of the controlled-environment facility, for example limiting the availability of a Wi-Fi signal providing the stream through the placement of wireless access points, antenna directionality of such wireless access points, and/or the like. Also, the IRD may have a few fixed apps pre-installed on the device, and installation of further apps on the device may be forbidden (i.e., prevented by modifications to the device's operating system, or the like) and/or restricted, such as by requiring permission from a facility administrator, or the like. Apps provided on an IRD might include apps of particular interest to residents of the controlled-environment facility. For example, an IRD provided to inmates of correctional facilities, might include apps that may be of particular use to an inmate, in general, such as access to a legal research service, or of more specific interest, such as providing an inmate nearing release, access to employment searching apps or the like. Hence, such IRDs may be used to help soon to be released inmates' transition. For example, the IRD may be used to communicate with a future employer, or the like. As such, IRDs may be sponsored, or otherwise subsidized by organizations or companies, assisting with the transition of inmates into society. As noted, in accordance with embodiments of the present systems and methods, IRDs may be used to communicate with others, such as through phone calls, video calls, or the like. Further, in accordance with embodiments of the present systems and methods the IRDs may provide controlled-environment facility residents limited and/or monitored internet access. In accordance with embodiments of the present systems and methods, IRDs 115, 116, 125, 126, 135, 136, etc. may be employed to facilitate implementation of embodiments of the present systems and methods, and/or to carry out all or certain aspects of embodiments of the present systems and methods.

For a resident to initiate an outgoing communication, the resident may initiate telephone services by lifting the receiver on telephone 113, 123,133, etc. or IFD 114, 124, 134, etc. and/or otherwise initiating a call, such as by launching an app on IRD 115, 125, 135, 116, 126, 136, etc. At which time, the resident may be prompted to provide a PIN, other identifying information or biometrics. Interactive voice response (IVR) unit 127, 137 or 147, which may be integrated into communication processing system 121, 131 and/or 141, as illustrated, may generate and play a prompt or other messages to the resident. Under the control of communication processing system 121, 131 and/or 141, etc. the device may be capable of connecting with a non-resident's device (e.g., telephone 163, non-resident computer 164, non-resident tablet computing device 165, non-resident smartphone/media player 166, or the like) across public network 170, such as a publicly switched telephone network (PSTN), an Integrated Services Digital Network (ISDN), Voice-over-IP (VoIP) or packet data network, such as for example the Internet, etc. Network 170 may be the same, or a different network, such as network 150. Telephony switches 128, 138, 148 etc. in respective communication processing system 121, 131, 141, etc. may be used to connect calls across a PSTN (i.e., network 170), such as calls from controlled-environment facility telephone 113, 123 or 133 and non-resident telephone 163, which, in accordance with embodiments of the present systems and methods, may also be camera-enabled. Telephony router 129, 139, 149, etc., media gateway functionality, or the like of respective communication system 121, 131, 141, etc. may be used to route data packets associated with a digital call connection, via an Integrated Services Digital Network (ISDN), the Internet, or the like (i.e., network 170). For example, a non-resident party may have a personal or laptop computer 164 with a webcam, or the like, or devices 165 or 166 may have an integrated camera and display (e.g., a smart phone, tablet, etc.). A network connection between the parties may be established and supported by an organization or commercial service that provides computer services and software for use in telecommunications and/or VoIP, such as SKYPE®. Additionally, or alternatively, the correctional facility and/or the destination may use videoconferencing equipment compatible with ITU H.323, H.320, H.264, and/or V.80, or other suitable standards. In accordance with various embodiments of the present systems and methods, non-resident's devices, telephone 163, non-resident computer 164, non-resident tablet computing device 165, non-resident smartphone/media player 166, and/or the like, may be disposed in the non-resident's home, place of work, on their person, or the like. Additionally, or alternatively the non-resident devices may be disposed in a visitation area of controlled-environment facility 110, 120, 130, etc., which may be within, adjacent to, or remote with respect to controlled-environment facility 110, 120, 130, etc., itself.

Computer-based environment components may include programming and/or hardware to implement embodiments of the present systems and methods. This programming may take the form of stored program instructions, programed firmware, or the like, while hardware might take the form of an Application Specific Integrated Circuit (ASIC), or the like, to carry out such aspects of embodiments of the present systems and methods.

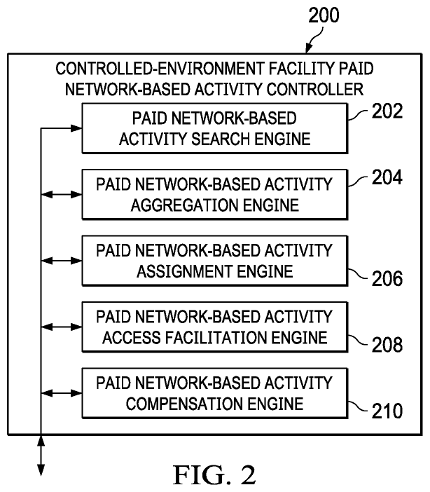

FIG. 2 is a diagrammatic block illustration of by example controlled-environment facility paid network-based activity controller 200, according to some embodiments. Controlled-environment facility paid network-based activity controller 200 may be standalone server, or similar device. Additionally, or alternatively, controlled-environment facility paid network-based activity controller 200 may include programming and/or hardware to implement embodiments of the present systems and methods. This programming may take the form of stored program instructions, programed firmware, or the like, while hardware might take the form of an Application Specific Integrated Circuit (ASIC), or the like, to carry out such aspects of embodiments of the present systems and methods. Alternatively, or additionally, controlled-environment facility paid network-based activity controller 200 may be a hardware and/or software module, or the like, of controlled-environment facility communication processing system 121, 131, 141, etc., of controlled-environment facility administration and management system 122, 132, 142, etc., and/or the like.

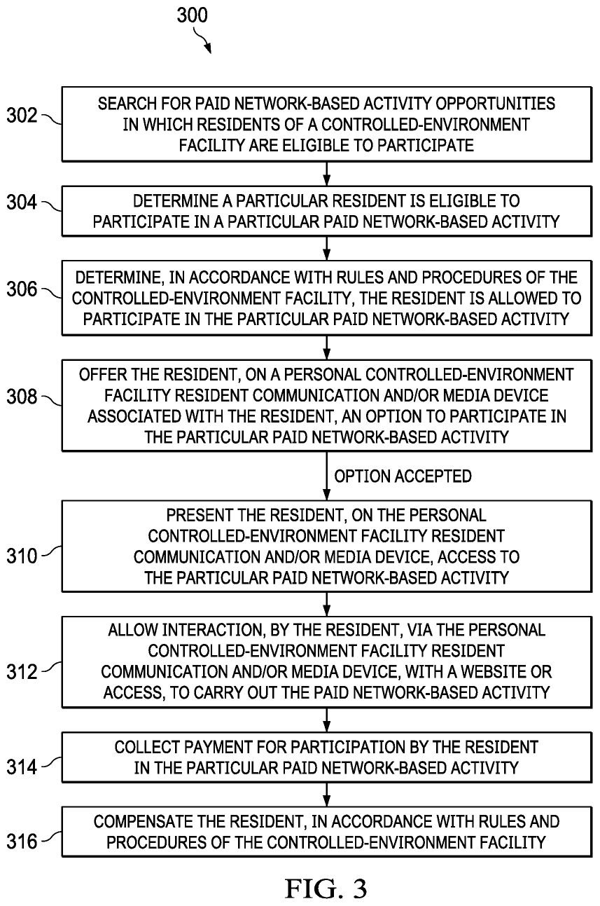

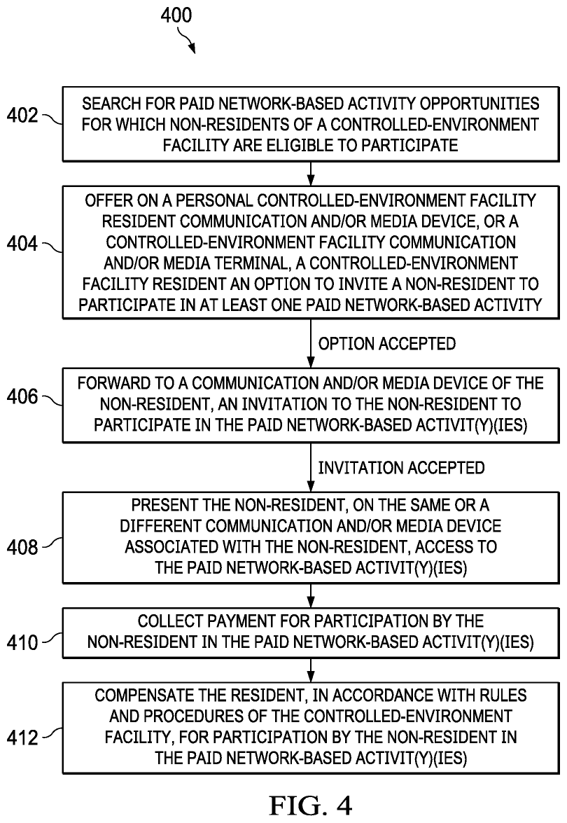

Controlled-environment facility paid network-based activity controller 200 may comprise a number of engines, which may alone, in conjunction with other engines of controlled-environment facility paid network-based activity controller 200, in conjunction with controlled-environment facility communication processing system 121, 131, 141, etc., controlled-environment facility AMS 122, 132, 142, etc., and/or the like, carryout various operations of various embodiments of the present systems and methods, as detailed further below with respect to FIGS. 3 and 4. The engines of controlled-environment facility paid network-based activity controller 200 may include, by way of example, paid network-based activity search engine 202, paid network-based activity aggregation engine 204, paid network-based activity assignment engine 206, paid network-based activity access facilitation engine 208, paid network-based activity compensation engine 210, and/or the like.

FIG. 3 is a flowchart of example process 300 for controlled-environment facility resident access to paid network-based activities, in accordance with some embodiments. Therein, at 302, a controlled-environment facility paid network-based activity search engine (202), or the like, such as of a controlled-environment facility paid network-based activity controller (200), or the like, of a controlled-environment facility communication processing system (121, 131, 141), a controlled-environment facility AMS (122, 132, 142), and/or the like, may search for paid network-based activity (e.g., pay-for-view) opportunities for which residents (e.g., inmates) of a controlled-environment facility (e.g., correctional facility) are eligible to participate. As noted, such paid network-based activities may include, by way of example, taking online surveys, watching online videos, playing games, redeeming online coupon(s), reading online post(s), reading email(s), shopping online, or the like. These paid network-based activities may be paid internet activities, activities offered via a controlled-environment facility network or intranet, (e.g., via a private network (via a secure tunneling protocol over the internet, using encapsulation)), or the like.

A controlled-environment facility paid network-based activity aggregation engine (204), or the like, such as of the controlled-environment facility paid network-based activity controller, or the like, may also aggregate a plurality of paid network-based activity opportunities found at 302, for which residents of a controlled-environment facility are eligible to participate.

At 304, a controlled-environment facility paid network-based activity assignment engine (206), or the like, such as of the controlled-environment facility paid network-based activity controller, or the like, may determine that a particular resident of the controlled-environment facility is eligible to participate in a particular paid network-based activity, such as in accordance with rules established by an entity sponsoring, or otherwise offering the paid network-based activity. Likewise, at 306, the controlled-environment facility paid network-based activity controller assignment engine, or the like, may determine, in accordance with rules and procedures of the controlled-environment facility, such as may be maintained by the controlled-environment facility AMS (122, 132, 142) that the particular resident is allowed to participate in the particular paid network-based activity. For example, the resident (inmate) may have communications restrictions in place for disciplinary or security reasons (such as maintained by the controlled-environment facility AMS, in accordance with the rules and regulations of the controlled-environment facility) that would prevent the resident (inmate) from participating in such a paid network-based activity, or even accessing the website(s), or other server-based locations, necessary to do so.

At 308, the controlled-environment facility paid network-based activity assignment engine, or the like, such as of the controlled-environment facility paid network-based activity controller, or the like, may offer the particular resident an option, on a controlled-environment facility resident communication and/or media device, to participate in the particular paid network-based activity. In accordance with some embodiments of the present systems and methods, the particular resident may be offered the option to participate in the particular paid network-based activity at 308 during initiation of an electronic communication (e.g., telephone call, video call or visitation, an email, e-message, etc.) by that particular resident. The offer may enable the resident to pay for the electronic communication, at least in part, by participating in the network activity.

In response to acceptance of this option to participate in the particular paid network-based activity by the particular resident, the controlled-environment facility paid network-based activity access facilitation engine (208), or the like, such as of the controlled-environment facility paid network-based activity controller, or the like, may, at 310, present the particular resident a method, such as a link (hyperlink), on the controlled-environment facility resident communication and/or media device, to access the particular paid network-based activity.

With respect to an aggregated plurality of paid network-based activities, the determination whether the particular resident of the controlled-environment facility is eligible to participate in the particular paid network-based activity at 304 and whether the particular resident is allowed to participate in the particular paid network-based activity at 306 may be carried out for each paid network-based activity of the plurality of paid network-based activity opportunities. Whereupon, in accordance with embodiments of the present systems and methods, eligible residents may be presented further links or access methods to further paid network-based activities, (at 310) as each is completed.

At 312, the controlled-environment facility paid network-based activity access facilitation engine, or the like, such as of the controlled-environment facility paid network-based activity controller, or the like, may, allow interaction, by the particular controlled-environment facility resident, via the personal controlled-environment facility resident communication and/or media device, with a website provided via the link or any other method to access the paid network-based activity. This access at 312 may be provided over an access block in place in accordance with rules and procedures of the controlled-environment facility, such as may be implemented by, or in conjunction with, and/or allowed over (and in conjunction with) the controlled-environment facility AMS (122, 132, 142).

At 314 the controlled-environment facility paid network-based activity compensation engine (210), or the like, such as of the controlled-environment facility paid network-based activity controller, or the like, may collect payment for participation by the particular resident in the particular paid network-based activity, from the entity sponsoring, or otherwise offering the paid network-based activity. The controlled-environment facility paid network-based activity compensation engine, or the like may then, in accordance with rules and procedures of the controlled-environment facility, and hence may in cooperation with the AMS, compensate the particular resident at 316. This may include adding credit to a trust, media, commissary, communication or similar account maintained, such as by the AMS (122, 132, 142), to the benefit of the particular resident. These credits may be used for present, past or future expenses. The compensation may allow residents to use such credits, or similar compensation for media, video, television shows, tablet or smartphone accessories, such as tablet or smartphone cases or tablet keyboards, music, games, movies, tangible items including commissary, food beverage, toiletries, etc.

In instances where participation in the network-based activity was offered at 308 (during initiation of an electronic communication) to pay for the electronic communication, this compensation at 316 may take the form of paying for the electronic communication, at least in part, to the extent of the payment for participation by the particular resident in the particular paid network-based activity, and as a result of participation by the particular resident in the particular paid network-based activity. To wit, such participation in the network-based activity may be required before the electronic communication is connected to garner such payment.

Thereby, embodiments of the present systems and methods enable not only controlled-environment facility residents (inmates), who typically have limited funds for communication services, premium content, or the like, to make practical use of time on their hands to generate income in a practical manner, but also, enable a sponsor or other entity offering the paid network-based activity practical access to an audience with copious amounts of time on their hands to complete such network-based activities.

FIG. 4 is a flowchart of example process 400 for controlled-environment facility resident-initiated non-resident access to paid network-based activities, in accordance with some embodiments. Therein, at 402, the controlled-environment facility paid network-based activity search engine (202), or the like, such as of a controlled-environment facility paid network-based activity controller (200), or the like, of a controlled-environment facility communication processing system (121, 131, 141), a controlled-environment facility AMS (122, 132, 142), and/or the like, may, additionally or alternatively, search for paid network-based activity opportunities, not only for controlled-environment facility residents (e.g., inmates), but also for non-residents (e.g., friends and family of a resident/inmate). These paid network-based activities may also include, by way of example, taking online surveys, watching online videos, playing games, redeeming online coupon(s), reading online post(s), reading email(s), shopping online, or the like. These paid network-based activities may be paid internet activities, activities offered via a controlled-environment facility network or intranet, (e.g., via a private network (via a secure tunneling protocol over the internet, using encapsulation)), or the like. The results may be aggregated such as by the controlled-environment facility paid network-based activity aggregation engine (204), or the like, such as of the controlled-environment facility paid network-based activity controller, or the like, at 402.

In such embodiments, the controlled-environment facility paid network-based activity assignment engine (206), or the like, such as of the controlled-environment facility paid network-based activity controller, or the like, may, at 404, offer a controlled-environment facility resident operating a controlled-environment facility communication and/or media device, an option to select, or otherwise name, and invite, a non-resident to participate in at least one such paid network-based activity.

In accordance with such embodiments of the present systems and methods, the controlled-environment facility paid network-based activity assignment engine, or the like, such as of the controlled-environment facility paid network-based activity controller, or the like, may forward, via the controlled-environment facility communications processing system (121, 131, 141), or the like, an invitation to the non-resident to participate in the paid network-based activit(y)(ies), at 406, in response to selection of the option offered at 404, by the controlled-environment facility resident, to invite the non-resident to participate. This invitation sent at 406 may be sent in the name of the resident, for the benefit of the resident (e.g., “Inmate John Smith would like for you to participate in an internet survey. Your participation will result in credit being added to John Smith's media, commissary and/or communications account.”).

In response to the non-resident accepting the invitation presented to the non-resident at 406 to participate in the paid network-based activit(y)(ies), the controlled-environment facility paid network-based activity access facilitation engine (208), or the like, such as of the controlled-environment facility paid network-based activity controller, or the like, may present, via the controlled-environment facility communications processing system, on a communication and/or media device (164, 165, 166) associated with the non-resident, the non-resident a method to access the paid network-based activit(y)(ies), at 408, in response to the non-resident accepting the invitation to participate in paid network-based activit(y)(ies).

At 410, the controlled-environment facility paid network-based activity compensation engine (210), or the like, such as of the controlled-environment facility paid network-based activity controller, or the like, may collect payment for participation by the non-resident in the paid network-based activit(y)(ies), such as from the entity sponsoring, or otherwise offering the paid network-based activit (y)(ies).

In accordance with these embodiments of the present systems and methods, the controlled-environment facility paid network-based activity compensation engine, or the like, such as of the controlled-environment facility paid network-based activity controller, or the like, may at 412, compensate the resident that invited the non-resident to participate in the paid network-based activit (y)(ies), but in accordance with rules and procedures of the controlled-environment facility. This compensation is for participation by the non-resident in the paid network-based activit (y)(ies). Compensation of the resident that invited the non-resident to participate may include adding credit to a trust, media, commissary, communication or similar account maintained, such as by the AMS (122, 132, 142), to the benefit of the resident. These credits may be used for present, past or future expenses. The compensation may allow residents to use such credits, or similar compensation for media, video, television shows, tablet or smartphone accessories, such as tablet or smartphone cases or tablet keyboards, music, games, movies, tangible items including commissary, food beverage, toiletries, etc.

Similar to process 300 above, in process 400, the offer to the controlled-environment facility resident of the option to invite the non-resident to participate in the paid network-based activit(y)(ies) at 404 may be made during initiation of an electronic communication (e.g., telephone call, video call or visitation, an email, e-message, etc.) by the resident, for payment of the electronic communication, at least in part. In accordance with such embodiments the resident may be compensated at 412 by paying for the electronic communication, at least in part, to the extent of the payment for participation by the non-resident in the paid network-based activit(y)(ies), and as result of participation by the non-resident in the paid network-based activit(y)(ies). Again, such participation in the network-based activit (y)(ies) may be required before the electronic communication is connected to garner such payment.

Thereby, embodiments of the present systems and methods not only enable controlled-environment facility residents (inmates), who typically have limited funds for communication services, premium content, or the like, to make use of time on their hands to generate income, but also, enable such an inmate (resident) to enlist friends, family members, or the like to complete such internet activities, providing sponsors, or other entities offering paid network-based activity, access to an even broader audience, one motivated to assist their incarcerated family member or friend in a practical manner.

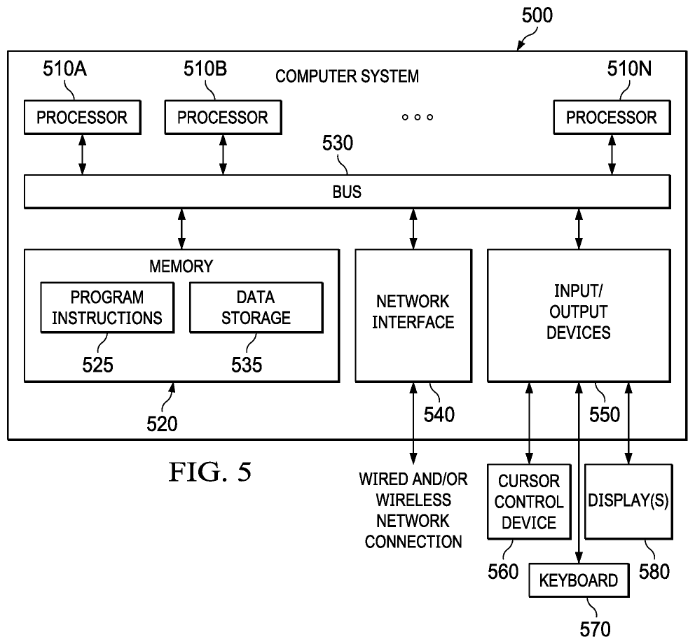

Embodiments of the present systems and methods for controlled-environment facility resident access to paid network-based activities, as described herein, may be implemented at least in part as, or executed, at least in part, by one or more computer systems. One such computer system is illustrated in FIG. 5. In various embodiments, computer system 500 may be a server, a mainframe computer system, a workstation, a network computer, a desktop computer, a laptop, a tablet computing device, media player, or the like. For example, in some cases, computer 500 may implement one or more steps of example processes 300 and/or 400 described above with respect to FIGS. 3 and 4, and/or a computer system such as computer system 500 may be used as part of, one or more of: AMSs 122, 132 and/or 142; controlled environment facility communications processing systems 121, 131 and/or 141; controlled-environment facility resident communications devices 113 through 116, 123 through 126, and 133 through 136; non-resident communications devices 163 through 166; and/or the like. In various embodiments two or more of these computer systems may be configured to communicate with each other in any suitable way, such as, for example, via network 150 and/or public network 170, which may be the Internet, or the like, as discussed above, via a local area network using wired or wireless functionality, etc.

As illustrated, computer system 500 includes one or more processors 510A-N coupled to a system memory 520 via bus 530. Computer system 500 further includes a network interface 540 coupled to bus 530, and one or more I/O controllers 550, which in turn are coupled to peripheral devices such as cursor control device 560, keyboard 570, display(s) 580, etc. Each of I/O devices 560, 570, 580 may be capable of communicating with I/O controllers 550, for example, via a wired connection (e.g., serial port, Universal Serial Bus port) or wireless connection (e.g., Wi-Fi, Bluetooth, Near Field Communications Link, etc.). Other devices may include, for example, microphones, antennas/wireless transducers, phone detection modules, etc.

In various embodiments, computer system 500 may be a single-processor system including one processor 510A, or a multi-processor system including two or more processors 510A-N (e.g., two, four, eight, or another suitable number). Processors 510 may be any processor capable of executing program instructions. For example, in various embodiments, processors 510 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 510 may commonly, but not necessarily, implement the same ISA. Also, in some embodiments, at least one processor 510 may be a graphics processing unit (GPU) or another dedicated graphics-rendering device.

System memory 520 may be configured to store program instructions and/or data accessible by processor 510. In various embodiments, system memory 520 may be implemented using any suitable memory technology, such as static random-access memory (SRAM), synchronous dynamic RAM (SDRAM), nonvolatile/Flash-type memory, or any other type of memory. As illustrated, program instructions and data implementing certain operations and modules such as those described herein may be stored within system memory 520 as program instructions 525 and data storage 535, respectively. In other embodiments, program instructions and/or data may be received, sent, or stored upon different types of computer-accessible media or on similar media separate from system memory 520 or computer system 500.

A computer-accessible medium may include any tangible and/or non-transitory storage media or memory media such as electronic, magnetic, or optical media—e.g., disk or CD/DVD-ROM coupled to computer system 500 via bus 530. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 530 may be configured to coordinate I/O traffic between processor 510, system memory 520, and any peripheral devices in the computer system, including network interface 540 or other peripheral interfaces, such as I/O devices 560, 570, 580. In some embodiments, bus 530 may perform any necessary protocol, timing, or other data transformations to convert data signals from one component (e.g., system memory 520) into a format suitable for use by another component (e.g., processor 510). In some embodiments, bus 530 may include support for devices attached through various types of peripheral buses, such as a variant of the Peripheral Component Interconnect (PCI) bus standard or the Universal Serial Bus (USB) standard, for example. In some embodiments, the function of bus 530 may be split into two or more separate components, such as a northbridge chipset and a southbridge chipset, for example. In addition, in some embodiments some or all the functionality of bus 530, such as an interface to system memory 520, may be incorporated directly into processor(s) 510A-N.

Network interface 540 may be configured to allow data to be exchanged between computer system 500 and other devices attached to a network, such as other computer systems, or between nodes of computer system 500. In various embodiments, network interface 540 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

I/O controllers 550 may, in some embodiments, enable communications with one or more display terminals, keyboards, keypads, touchpads, scanning devices, voice or optical recognition devices, mobile devices, or any other devices suitable for entering or retrieving data by one or more computer system 500. Multiple I/O controllers 550 may be present in computer system 500 or may be distributed on various nodes of computer system 500. In some embodiments, I/O devices may be separate from computer system 500 and may interact with one or more nodes of computer system 500 through a wired or wireless connection, such as over network interface 540.

As shown in FIG. 5, system memory 520 may include program instructions 525, configured to implement certain embodiments described herein, and data storage 535, comprising various data may be accessible by program instructions 525. In an embodiment, program instructions 525 may include software elements, which may be configured to affect the operations discussed in FIGS. 1 through 4. Program instructions 525 may be implemented in various embodiments using any desired programming language, scripting language, or combination of programming languages and/or scripting languages (e.g., C, C++, C #, JAVA®, JAVASCRIPT®, PERL®, etc.). Data storage 535 may include data that may be used in these embodiments (e.g., recorded communications, profiles for different modes of operations, etc.). In other embodiments, other or different software elements and data may be included.

A person of ordinary skill in the art will appreciate that computer system 500 is merely illustrative and is not intended to limit the scope of the disclosure described herein. The computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

The various operations described herein, particularly in connection with FIGS. 1 through 5, may be implemented in software executed by processing circuitry, hardware, or a combination thereof. The order in which each operation of a given method is performed may be changed, and various operations may be added, reordered, combined, omitted, modified, etc. It is intended that embodiment(s) described herein embrace all such modifications and changes and, accordingly, the above description should be regarded in an illustrative rather than a restrictive sense.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A system comprising:
a controlled-environment facility paid network-based activity controller of a controlled-environment facility communication processing system and/or a controlled-environment facility administration and management system, associated with at least one processor of the controlled-environment facility communication processing system and/or controlled-environment facility administration and management system, and associated with a memory coupled to the at least one processor, the memory configured to store program instructions executable by the at least one processor to cause the controlled-environment facility paid network-based activity controller to:
search for paid network-based activity opportunities for which residents of a controlled-environment facility are eligible to participate;
determine a particular resident of the controlled-environment facility is eligible to participate in a particular paid network-based activity, and, in accordance with rules and procedures of the controlled-environment facility, the particular controlled-environment facility resident is allowed to participate in the particular paid network-based activity;
offer, on a personal controlled-environment facility resident communication and/or media device associated with the particular controlled-environment facility resident and adapted for use of the particular resident, within the controlled-environment facility, including to only connect to a network provided by the controlled-environment facility, the particular controlled-environment facility resident an option to participate in the particular paid network-based activity;
present, on the personal controlled-environment facility resident communication and/or media device associated with the particular controlled-environment facility resident, the particular controlled-environment facility resident access to the particular paid network-based activity, in response to acceptance of the option to participate in the particular paid network-based activity by the particular controlled-environment facility resident;
allow interaction, by the particular controlled-environment facility resident, in accordance with rules and procedures of the controlled-environment facility, via the personal controlled-environment facility resident communication and/or media device associated with the particular controlled-environment facility resident, via access that would otherwise be blocked in accordance with rules and procedures of the controlled-environment facility, to carry out the paid network-based activity;
collect payment for participation by the particular controlled-environment facility resident in the particular paid network-based activity; and
compensate, in accordance with rules and procedures of the controlled-environment facility, the particular controlled-environment facility resident.

2. The system of claim 1, wherein the controlled-environment facility is a correctional facility, the residents are inmates of the correctional facility, and each of the personal controlled-environment facility resident communication and/or media devices are adapted for use of a particular inmate within the correctional facility.

3. (canceled)

4. The system of claim 1, wherein execution of the program instructions further cause the controlled-environment facility paid network-based activity controller to:
aggregate a plurality of the paid network-based activity opportunities for which residents of a controlled-environment facility are eligible to participate;
determine the particular resident of the controlled-environment facility is eligible to participate in the particular paid network-based activity, and the particular controlled-environment facility resident is allowed to participate in the particular paid network-based activity for each paid network-based activity of the plurality of paid network-based activity opportunities aggregated; and
present, on the personal controlled-environment facility resident communication and/or media device associated with the particular controlled-environment facility resident, the particular controlled-environment facility resident further access to another particular paid network-based activity.

5. The system of claim 1, wherein execution of the program instructions further cause the controlled-environment facility paid network-based activity controller to:
make the offer to the particular controlled-environment facility resident the option to participate in the particular paid network-based activity during initiation of an electronic communication by the particular resident, for payment of the electronic communication, at least in part; and
compensate the particular controlled-environment facility resident comprises paying for the electronic communication, at least in part, to the extent of the payment for participation by the particular resident in the particular paid network-based activity, and as result of participation by the particular resident in the particular paid network-based activity.

6. The system of claim 1, wherein execution of the program instructions further cause the controlled-environment facility paid network-based activity controller to:
search for paid network-based activity opportunities for which non-residents of a controlled-environment facility are eligible to participate;
offer on the personal controlled-environment facility resident communication and/or media device, or a controlled-environment facility communication and/or media terminal, a same or different particular controlled-environment facility resident an option to invite a non-resident to participate in at least one paid network-based activity;
forward, via a controlled-environment facility communication processing system, to a communication and/or media device of the non-resident, an invitation to the non-resident to participate in the at least one paid network-based activity, in response to a selection of the option to invite the non-resident to participate by the same or different particular controlled-environment facility resident;
present, via the controlled-environment facility communication processing system, on the same or a different communication and/or media device associated with the non-resident, the non-resident access to each of the at least one paid network-based activity, in response to the non-resident accepting the invitation to participate in the at least one paid network-based activity;
collect payment for participation by the non-resident in the at least one paid network-based activity; and
compensate in accordance with rules and procedures of the controlled-environment facility, the same or different particular controlled-environment facility resident for participation by the non-resident in the at least one paid network-based activity.

7. The system of claim 1, wherein the paid network-based activity comprises:
taking an online survey;
watching an online video;
playing an online game;
redeeming one or more online coupons;
reading one or more online posts;
reading one or more emails; or
shopping online.

8. A method comprising:
searching, by a controlled-environment facility paid network-based activity controller, for paid network-based activity opportunities for which residents of a controlled-environment facility are eligible to participate;
aggregating, by the controlled-environment facility paid network-based activity controller, a plurality of the paid network-based activity opportunities for which residents of a controlled-environment facility are eligible to participate;
determining, by the controlled-environment facility paid network-based activity controller, for each paid network-based activity of the plurality of paid network-based activity opportunities, a particular resident of the controlled-environment facility is eligible to participate in a particular paid network-based activity, and, in accordance with rules and procedures of the controlled-environment facility, the particular controlled-environment facility resident is allowed to participate in the particular paid network-based activity;
offering, by the controlled-environment facility paid network-based activity controller, on a personal controlled-environment facility resident communication and/or media device associated with the particular controlled-environment facility resident and adapted for use of the particular resident, within the controlled-environment facility, including to only connect to a network provided by the controlled-environment facility, the particular controlled-environment facility resident an option to participate in the particular paid network-based activity;
presenting, by the controlled-environment facility paid network-based activity controller, on the personal controlled-environment facility resident communication and/or media device associated with the particular controlled-environment facility resident, the particular controlled-environment facility resident access to the particular paid network-based activity, in response to acceptance of the option to participate in the particular paid network-based activity by the particular controlled-environment facility resident;
allowing, by the controlled-environment facility paid network-based activity controller, on the personal controlled-environment facility resident communication and/or media device associated with the particular controlled-environment facility resident, interaction, by the particular controlled-environment facility resident, in accordance with rules and procedures of the controlled-environment facility, via the personal controlled-environment facility resident communication and/or media device associated with the particular controlled-environment facility resident, with a website or access to carry out the paid network-based activity;
collecting, by the controlled-environment facility paid network-based activity controller, payment for participation by the particular controlled-environment facility resident in the particular paid network-based activity; and
compensating, by the controlled-environment facility paid network-based activity controller, in accordance with rules and procedures of the controlled-environment facility, the particular controlled-environment facility resident for participation by the particular controlled-environment facility resident in the particular paid network-based activity.

9. The method of claim 8, wherein the controlled-environment facility is a correctional facility, the residents are inmates of the correctional facility, and the personal controlled-environment facility resident communication and/or media devices is adapted for use of a particular inmate within the correctional facility.

10. The method of claim 8, further comprising allowing the interaction, by the particular controlled-environment facility resident, with the website or access to carry out the paid network-based activity over access that would otherwise be blocked in accordance with rules and procedures of the controlled-environment facility.

11. (canceled)

12. The method of claim 8, wherein offering the particular controlled-environment facility resident the option to participate in the particular paid network-based activity is made during initiation of an electronic communication by the particular resident, for payment of the electronic communication, at least in part, and compensating the particular controlled-environment facility resident comprises paying for the electronic communication, at least in part, to the extent of the payment for participation by the particular resident in the particular paid network-based activity, and as result of participation by the particular resident in the particular paid network-based activity.

13. The method of claim 8, further comprising:
searching, by the controlled-environment facility paid network-based activity controller, for paid network-based activity opportunities for which non-residents of a controlled-environment facility are eligible to participate;
offering, by the controlled-environment facility paid network-based activity controller, on the personal controlled-environment facility resident communication and/or media device, the particular controlled-environment facility resident an option to invite a non-resident to participate in at least one paid network-based activity;
forwarding, by the controlled-environment facility paid network-based activity controller, via a controlled-environment facility communication processing system, an invitation to the non-resident to participate in the at least one paid network-based activity, in response to selection of the option to invite the non-resident to participate by the particular controlled-environment facility resident;
presenting, by the controlled-environment facility paid network-based activity controller, via the controlled-environment facility communication processing system, on a communication and/or media device associated with the non-resident, the non-resident access to the at least one paid network-based activity, in response to the non-resident accepting the invitation to participate in the at least one paid network-based activity;
collecting, by the controlled-environment facility paid network-based activity controller, payment for participation by the non-resident in the at least one paid network-based activity; and
compensating, by the controlled-environment facility paid network-based activity controller, in accordance with rules and procedures of the controlled-environment facility, the controlled-environment facility resident for participation by the non-resident in the at least one paid network-based activity.

14. The method of claim 8, wherein the paid network-based activity comprises:
taking an online survey;
watching an online video;
playing an online game;
redeeming one or more online coupons;
reading one or more online posts;
reading one or more emails; or
shopping online.

15. The method of claim 8, wherein compensating the particular controlled-environment facility resident for participation by the particular controlled-environment facility resident in the particular paid network-based activity further comprises allowing the particular controlled-environment facility resident to use compensation to purchase media content, video content, television shows, personal controlled-environment facility resident communication and/or media device accessories, personal controlled-environment facility resident communication and/or media device cases, personal controlled-environment facility resident communication and/or media device keyboards, music content, games, movies, commissary items, food, beverage and/or toiletries.

16. A method comprising:
searching, by a controlled-environment facility paid network-based activity controller, for paid network-based activity opportunities for which non-residents of a controlled-environment facility are eligible to participate;
offering, by the controlled-environment facility paid network-based activity controller, on a controlled-environment facility communication and/or media device adapted for use of a controlled-environment facility resident within the controlled-environment facility, including to only connect to a network provided by the controlled-environment facility, the controlled-environment facility resident an option to invite a non-resident to participate in at least one paid network-based activity which the non-residents is eligible to participate;
forwarding, by the controlled-environment facility paid network-based activity controller, via a controlled-environment facility communication processing system, an invitation to the non-resident to participate in the at least one paid network-based activity, in response to selection of the option to invite the non-resident to participate by the controlled-environment facility resident;
presenting, by the controlled-environment facility paid network-based activity controller, via the controlled-environment facility communication processing system, on a communication and/or media device associated with the non-resident, the non-resident access to the at least one paid network-based activity, in response to the non-resident accepting the invitation to participate in at least one paid network-based activity;
collecting, by the controlled-environment facility paid network-based activity controller, payment for participation by the non-resident in the at least one paid network-based activity; and
compensating, by the controlled-environment facility paid network-based activity controller, in accordance with rules and procedures of the controlled-environment facility, the controlled-environment facility resident for participation by the non-resident in the at least one paid network-based activity.

17. The method of claim 16, wherein the controlled-environment facility is a correctional facility, the resident is an inmate of the correctional facility, and the personal controlled-environment facility resident communication and/or media devices is adapted for use of the inmate within the correctional.

18. The method of claim 16, wherein offering the controlled-environment facility resident the option to invite the non-resident to participate in at least one paid network-based activity is made during initiation of an electronic communication by the resident, for payment of the electronic communication, at least in part, and compensating the particular controlled-environment facility resident comprises paying for the electronic communication, at least in part, to the extent of the payment for participation by the non-resident in the at least one paid network-based activity, and as result of participation by the non-resident in the at least one paid network-based activity.

19. The method of claim 16, further comprising:
determining, by the controlled-environment facility paid network-based activity controller, the controlled-environment facility resident is eligible to participate in a particular paid network-based activity, and, in accordance with rules and procedures of the controlled-environment facility, the particular controlled-environment facility resident is allowed to participate in the particular paid network-based activity;
offering, by the controlled-environment facility paid network-based activity controller, on a personal controlled-environment facility resident communication and/or media device associated with the particular controlled-environment facility resident, the particular controlled-environment facility resident an option to participate in the particular paid network-based activity;
presenting, by the controlled-environment facility paid network-based activity controller, on the personal controlled-environment facility resident communication and/or media device associated with the particular controlled-environment facility resident, the particular controlled-environment facility resident access to the particular paid network-based activity;
collecting, by the controlled-environment facility paid network-based activity controller, payment for participation by the particular resident in the particular paid network-based activity; and
compensating, by the controlled-environment facility paid network-based activity controller, in accordance with rules and procedures of the controlled-environment facility, the particular controlled-environment facility resident.

20. The method of claim 19, further comprising allowing interaction, by the particular controlled-environment facility resident, via the personal controlled-environment facility resident communication and/or media device associated with the particular controlled-environment facility resident, with a website or access to carry out the paid network-based activity over access that would otherwise be blocked in accordance with rules and procedures of the controlled-environment facility.

21. The method of claim 16, wherein the paid network-based activity comprises:
taking an online survey;
watching an online video;
playing an online game;
redeeming one or more online coupons;
reading one or more online posts;
reading one or more emails; or
shopping online.

22. The method of claim 16, wherein compensating the controlled-environment facility resident for participation by the non-resident in the at least one paid network-based activity further comprises allowing the controlled-environment facility resident to use compensation to purchase media content, video content, television shows, personal controlled-environment facility resident communication and/or media device accessories, personal controlled-environment facility resident communication and/or media device cases, personal controlled-environment facility resident communication and/or media device keyboards, music content, games, movies, commissary items, food, beverage and/or toiletries.
